(19) United States
(12) Patent Application Publication
(10) Pub. No.: US 2026/0267134 A1
(43) Pub. Date: Sep. 10, 2026

(54) LENS UNIT, CAMERA MODULE, IMAGING SYSTEM, AND MOBILE BODY

(71) Applicant: Maxell, Ltd., Kyoto (JP)

(72) Inventors: Shinji FUJITA, Kyoto (JP); Yoshito YAMADA, Kyoto (JP); Junichi YOKOYAMA, Kyoto (JP); Yuki ISHII, Nagaokakyo-shi, Kyoto (JP); Hitoshi SAKAGUCHI, Nagaokakyo-shi, Kyoto (JP)

(73) Assignee: Maxell, Ltd., Kyoto (JP)

(21) Appl. No.: 19/166,475

(22) PCT Filed: Mar. 21, 2024
(86) PCT No.: PCT/JP2024/011152

§ 371 Date: Sep. 18, 2025

(30) Foreign Application Priority Data
Mar. 27, 2023 (JP) 2023-049473

(51) Int. Cl. G02B 27/00

(52) U.S. Cl. CPC G02B 27/0006

(57) ABSTRACT

A lens unit that includes a lens group, a lens barrel that houses and holds the lens group, and a vibration mechanism that vibrates a first lens located closest to an object side among the lens group, the vibration mechanism including a vibrator and a cylindrical vibrating body that is fixed to the vibrator and is vibrated by the vibrator, the lens unit comprising a ring-shaped lens holder that holds the first lens, the lens holder holding the first lens by at least an inner peripheral surface of the lens holder abutting on an outer peripheral surface of the first lens, the lens holder being directly or indirectly joined to an end of the vibrating body on the object side, and the first lens and a lens arranged closer to an image side than the first lens being arranged with a predetermined eccentricity amount or less.

### TECHNICAL FIELD

The present invention relates to a lens unit constituting an in-vehicle camera mounted on a vehicle such as an automobile, a camera module, an imaging system, and a mobile body on which the imaging system is mounted.

### BACKGROUND ART

Conventionally, an in-vehicle camera is mounted on an automobile to support parking and prevent collision by image recognition, and further, attempts have been made to apply this to automatic driving. Further, such a camera module of an in-vehicle camera or the like generally includes a lens unit including a lens group formed by arranging a plurality of lenses along an optical axis, a lens barrel (barrel) that houses and holds the lens group, and a diaphragm member disposed between lenses of at least one part of the lens group (see, for example, Patent Literature 1).

A vibration apparatus provided in a camera including a lens unit and configured to remove foreign matter such as water droplets and dust attached to a dome-shaped cover (lens cover) is known (see, for example, Patent Literature 2).

As illustrated in FIG. 11, the vibration apparatus 2 includes a dome-shaped cover 11, a cylindrical vibrating body 12 to which the cover 11 is fixed, and a piezoelectric device 13 that is fixed to the vibrating body 12 and vibrates the cover 11 via the vibrating body 12, in which the vibrating body 12 includes a cylindrical portion 14 having a first end 14a located on the cover 11 side and a second end 14b located on an opposite side of the cover 11, a cylindrical first connecting portion 15 connected to the first end 14a of the cylindrical portion 14 and formed of a cylinder having an inner diameter larger than that of the cylindrical portion 14, and a first ring-shaped portion 16 connected to the cover 11 side of the first connecting portion 15, having an inner diameter smaller than an inner diameter of the first connecting portion 15, and having a surface on the cover 11 side to which the cover 11 is fixed, a second connecting portion 17 connected to the second end 14b of the cylindrical portion 14 and formed of a cylinder having an outer diameter smaller than that of the cylindrical portion 14, and a second ring-shaped portion 18 fixed to a surface of the second connecting portion 17 opposite to a side to which the cylindrical portion 14 is connected and having an outer diameter larger than an outer diameter of the second connecting portion 17, in which the piezoelectric device 13 is fixed to a surface of the second ring-shaped portion 18 opposite to a side fixed to the second connecting portion 14b, and the cylindrical vibrating body 12 has a substantially S-shaped cross section in a radial cross section.

In such a vibration apparatus 2, the dome-shaped cover 11 can be vibrated with a larger amplitude, and movement of the droplets and atomization of the droplets can be more effectively achieved.

As described above, the vibration apparatus 2 includes the cylindrical vibrating body 12 and the piezoelectric device 13, in which the cover 11, which is a translucent component, is fixed to the vibrating body 12 and is ultrasonically vibrated to remove foreign matter adhering to the surface of the translucent component (cover) 11.

Further, the vibrating body 12 has a ring-shaped cross section that is orthogonal to a longitudinal direction, and has a bulged and constricted shape with continuously varying dimensions of the outer diameter and the inner diameter in an axial direction.

In addition, since the cover 11 as a translucent component is vibrated by the vibrating body 12, positional accuracy of the translucent component 11 is not sufficiently considered unlike the lens (lens module) 6 provided at an upper end of an imager 5.

### CITATION LIST

### Patent Literature

Patent Literature 1: JP 2013-231993 A

Patent Literature 2: JP 6977784 B2

### SUMMARY OF INVENTION

### Technical Problem

Incidentally, in order to achieve downsizing and high angle of view of the lens unit, consideration has been made to change the translucent component to a lens.

In a case where the translucent component is changed to a lens (first lens located closest to the object side), the vibrating body is fixed (joined) to the lens, but as described above, the vibrating body has a ring shape in a cross section orthogonal to the longitudinal direction, and has a shape bulging and constricting due to continuous change in dimensions of the outer diameter and the inner diameter in the axial direction, and is manufactured by turning processing. For this reason, in the manufactured vibrating body, dimensions of a lens mounting portion for mounting and fixing the first lens tend to vary. As a result, there is a problem that the position (particularly, the position in a radial direction) of the first lens mounted and fixed on the lens mounting portion varies, and the optical performance is deteriorated.

The present invention has been made in view of the above circumstances, and an object thereof is to provide a lens unit, a camera module, an imaging system, and a mobile body in which a first lens vibrated by a vibration mechanism can be positioned at a predetermined position without variation.

### Solution to Problem

In order to solve the above problem, a lens unit of the present invention includes a lens group in which a plurality of lenses is arranged along an optical axis of the lenses, a lens barrel that houses and holds the lens group, and a vibration mechanism that vibrates a first lens located closest to an object side among the plurality of lenses, in which
the vibration mechanism includes a vibrator and a cylindrical vibrating body that is fixed to the vibrator and is vibrated by the vibrator,
the lens unit includes a ring-shaped lens holder that holds the first lens,
the lens holder holds the first lens by at least an inner peripheral surface of the lens holder abutting on an outer peripheral surface of the first lens,
the lens holder is directly or indirectly joined to an end of the vibrating body on the object side, and
the first lens and a lens arranged closer to an image side than the first lens are arranged with a predetermined eccentricity amount or less.

The vibrating body is formed by turning processing using metal such as SUS, for example, but the lens holder may be formed by casting metal or injection molding resin in addition to being manufactured by the turning processing using metal.

Further, “the lens holder is indirectly joined to an end of the vibrating body on the object side” means that, for example, in a case where the lens holder is separated from the vibrating body, the lens holder is joined to the end of the vibrating body on the object side via another member.

In the present invention, the ring-shaped lens holder holding the first lens holds the first lens by at least an inner peripheral surface of the lens holder abutting on an outer peripheral surface of the first lens, and is joined to an end of the vibrating body on the object side.

As described above, since the ring-shaped lens holder is provided separately from the vibrating body, the lens holder can secure sufficient processing dimensional accuracy while suppressing variation even in turning processing. Since the first lens held by the lens holder and the lens arranged closer to the image side than the first lens are arranged with a predetermined eccentricity amount or less, the first lens can be positioned at a predetermined position without variation, and deterioration of optical performance can be suppressed.

Further, since the lens holder can be made of a material and by a manufacturing method different from those of the vibrating body, it is possible to suppress deterioration of optical performance by ensuring dimensional accuracy and securing a predetermined first lens position.

In addition, in the configuration of the present invention, the lens barrel may include:
a lens barrel main body that holds a lens disposed closer to the image side than the first lens; and a housing that is disposed radially outside the lens barrel main body and holds the first lens via the lens holder,
the lens holder is joined to the housing or formed integrally with the housing, and
the vibration mechanism is disposed radially inside the housing and radially outside the lens barrel main body.

The number of lenses arranged on the image side with respect to the first lens and held by the lens barrel main body may be one or plural. In a case where there is a plurality of lenses, the plurality of lenses and the first lens are arranged with a predetermined eccentricity amount or less.

With such a configuration, since the lens holder is joined to the housing or provided integrally with the housing, the lens holder can be reliably attached to a predetermined position. Further, since the vibration mechanism is disposed radially inside the housing and radially outside the lens barrel main body, the vibration mechanism can be protected by the housing, and the lenses arranged closer to the image side than the first lens are held by the lens barrel main body, so that the vibration mechanism does not interfere with the lenses.

In addition, in the configuration of the present invention, the lens holder may include an annular inner peripheral surface and an annular surface orthogonal to the inner peripheral surface, and
the inner peripheral surface may abut on an outer peripheral surface of the first lens, and the annular surface may abut on a bottom surface of the first lens facing the image side.

With such a configuration, since the inner peripheral surface of the lens holder abuts on the outer peripheral surface of the first lens and the annular surface of the lens holder abuts on the bottom surface facing the image side of the first lens, the first lens can be easily and accurately positioned in the radial direction and the axial direction (optical axis direction).

Further, the present invention also provides a camera module including the lens unit, an imaging system including the camera module, and a mobile body on which the imaging system is mounted. With such a camera module, an imaging system, and a mobile body, it is possible to obtain operations and effects similar to those of the lens unit described above. Note that the “mobile body” refers to all objects that can move, and examples thereof include vehicles and the like.

### Advantageous Effects of Invention

According to the present invention, a first lens vibrated by a vibration mechanism can be positioned at a predetermined position without variation.

### BRIEF DESCRIPTION OF DRAWINGS

FIG. 1 illustrates a first embodiment of the present invention, and is a schematic cross-sectional view of a lens unit.

FIG. 2 illustrates the lens unit, in which (a) is a perspective view of the lens unit, and (b) is a perspective view illustrating a vibration mechanism and a lens holder.

FIG. 3 illustrates a second embodiment of the present invention, and is a schematic cross-sectional view of a main part of a lens unit.

FIG. 4 illustrates a third embodiment of the present invention, and is a schematic cross-sectional view of a main part of a lens unit.

FIG. 5 illustrates a fourth embodiment of the present invention, and is a schematic cross-sectional view of a main part of a lens unit.

FIG. 6 illustrates a fifth embodiment of the present invention, and is a schematic cross-sectional view of a main part of a lens unit.

FIG. 7 illustrates a sixth embodiment of the present invention, and is a schematic cross-sectional view of a main part of a lens unit.

FIG. 8 is a schematic cross-sectional view of a camera module including the lens unit according to the first embodiment of the present invention.

FIG. 9 is a schematic view of a vehicle as a mobile body on which an imaging system (in-vehicle system) including a camera module according to an embodiment of the present invention is mounted.

FIG. 10 is a block diagram illustrating a configuration of an imaging apparatus constituting the imaging system illustrated in FIG. 9.

FIG. 11 is a schematic cross-sectional view of a conventional camera including a vibrating body.

### DESCRIPTION OF EMBODIMENTS

Hereinafter, an embodiment of the present invention will be described with reference to the drawings, and the present embodiment contributes to “9.1 Develop quality, reliable, sustainable and resilient infrastructure, including regional and transborder infrastructure, to support economic development and human well-being, with a focus on affordable and equitable access for all” of “9. Build the foundation for industry and technological innovation” of the Sustainable Development Goals (SDGs) proposed by the United Nations.

Note that the lens unit of the present embodiment described below is particularly for a camera module such as an in-vehicle camera, and for example, is fixedly installed on the outer surface side of an automobile, and wiring is drawn into the automobile and connected to a display or other apparatuses.

Note that the lens unit of the present embodiment described below is particularly for a camera module such as an in-vehicle camera, and for example, is fixedly installed on the outer surface side of an automobile, and wiring is drawn into the automobile and connected to a display or other apparatuses.

### First Embodiment

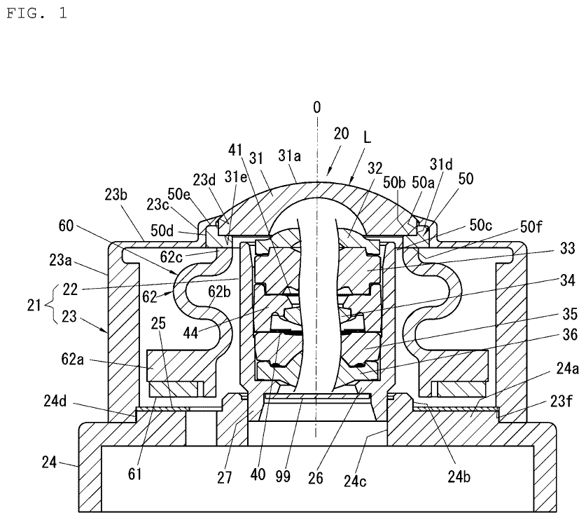

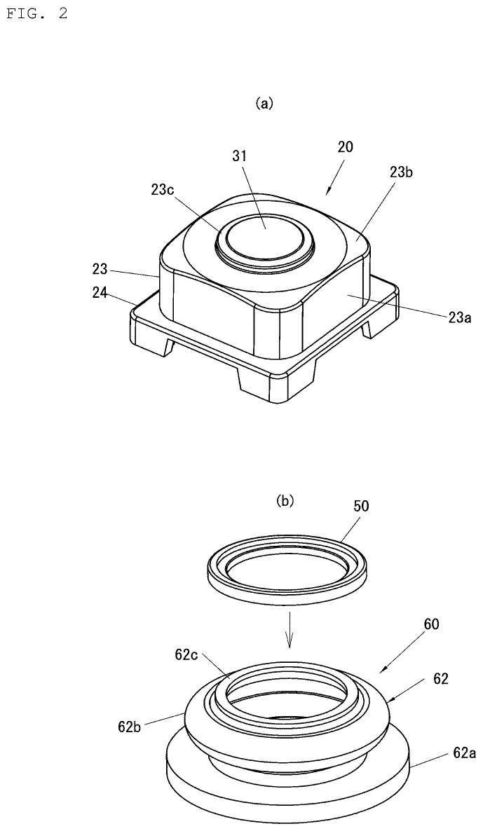

FIG. 1 illustrates a lens unit according to a first embodiment of the present invention, and is a schematic cross-sectional view of the lens unit, and FIG. 2 illustrates the lens unit, in which (a) is a perspective view of the lens unit, and (b) is a perspective view illustrating a vibration mechanism and a lens holder.

As illustrated in FIGS. 1 and 2, the lens unit 20 of the present embodiment includes a cylindrical lens barrel 21. The lens barrel 21 includes a cylindrical lens barrel main body 22 and a square cylindrical housing 23. Further, the lens unit 20 includes a square cylindrical support 24 that supports ends of the lens barrel main body 22 and the housing 23 on the image side (lower side in FIG. 1). The support 24 is shorter in length in an optical axis direction than the housing 23, but has an outer diameter and an inner diameter longer than those of the housing 23. Note that the optical axis is indicated by O, and a direction orthogonal to the optical axis O is a radial direction.

The housing 23 is disposed radially outside the lens barrel main body 22, and the support 24 is disposed closer to the image side (lower side in FIG. 1) than the housing 23. The lens barrel main body 22, the housing 23, and the support 24 are coaxially arranged.

A rectangular plate-shaped inner flange 24a is formed at an upper end of the support 24, a protrusion 24b protruding toward the object side (upper side in FIG. 1) is formed at a radial central of the inner flange 24a, and a through hole 24c is formed at a radial central of the protrusion 24b.

Further, a step 24d is formed on an upper surface of the inner flange 24a, and a lower end of the housing 23 is fitted to the step 24d. Thus, the housing 23 is positioned in the radial direction and the optical axis direction with respect to the support 24. Note that a disk-shaped spacer 25 is provided on the upper surface of the inner flange 24a on the radially inside of the step 24d, and the spacer 25 is pressed and fixed onto the upper surface of the inner flange 24a by a pressing surface 23f formed at the lower end of the housing 23.

In the lens barrel 21, a plurality of (for example, six) lenses 31, 32, 33, 34, 35, and 36 arranged in order from the object side, two diaphragm members 40 and 41, and one annular spacer 44 are provided.

The lens 31 is the first lens 31 located closest to the object side, and the first lens 31 is provided in the housing 23 via a lens holder 50 described later.

The five lenses 32, 33, 34, 35, and 36 arranged closer to the image side than the first lens 31, the two diaphragm members 40 and 41, and one annular spacer 44 are provided in the lens barrel main body 22.

Further, a cylindrical protrusion 27 protruding toward the image side (lower side in FIG. 1) is formed at a lower end of the lens barrel main body 22, and the protrusion 27 is inserted and fitted into the through hole 24c provided in the support 24. Thus, the lens barrel main body 22 and the support 24 are provided coaxially and coinciding with the optical axis O.

An in-vehicle camera including such a lens unit 20 includes a lens unit 20, a substrate having an image sensor (not illustrated), and an installation member (not illustrated) for installing the substrate in a vehicle such as an automobile.

Further, the first lens 31 located closest to the object side is a glass lens, and the lenses 32 to 36 are resin lenses, but it is not limited thereto (for example, the lens 31 may be a resin lens).

In addition, an antireflection film, a hydrophilic film, a water-repellent film, and the like are provided on the surface of the lenses 31 to 36 as necessary.

The plurality of lenses 31 to 36 fixed to and supported by the lens barrel 21 is arranged in a state where optical axes of the lenses are matched with each other, and the lenses 31 to 36 are arranged along one optical axis O to constitute one lens group L used for imaging.

Of the two diaphragm members 40 and 41, the first diaphragm member 41, counting from the object side (the upper end of the lens barrel main body 22), is disposed between the third lens 33, also counting from the object side, and the spacer 44. The second diaphragm member 40, counting from the object side, is disposed between the spacer 44 and the fifth lens 35, counting from the object side.

The diaphragm members 40 and 41 are “aperture diaphragms” that limit the amount of transmitted light and determine an F value to be an index of brightness, or “light-shielding diaphragms” that shield light beams that cause ghosts and light beams that cause aberrations.

Further, in the present embodiment, the housing 23 is disposed radially outside the lens barrel main body 22.

The housing 23 is formed of metal such as SUS, and includes a square cylindrical housing main body 23a, a top plate 23b having a rectangular plate shape integrally formed with the housing main body 23a at an upper end of the housing main body 23a, and a pressing portion 23c integrally formed with the top plate 23b at an edge of a through hole formed at a center of the top plate 23b.

A thickness (thickness in the optical axis direction) of the top plate 23b is thinner than a thickness (thickness in the radial direction) of the housing main body 23a.

The pressing portion 23c is formed in a substantially cylindrical shape, protrudes toward the object side (upper side in FIG. 1) from the top plate 23b, is bent radially inward from this protruding end, and has an inclined surface 23d inclined with respect to the optical axis O formed at a distal end edge along a circumferential direction.

Then, the inclined surface 23d presses a surface edge of the first lens 31 to fix the first lens 31. That is, in a state where the lens group L is incorporated and housed and held in the lens barrel 21, the first lens 31 located closest to the object side of the lens group L is pressed by the inclined surface 23d of the pressing portion 23c and fixed to an object side end of the lens barrel 21 (object side end of the housing 23) in the optical axis direction.

Further, an inner flange 26 having an aperture having a diameter smaller than that of the sixth lens 36 is provided at an end (lower end in FIG. 1) of the lens barrel main body 22 on the image side. The plurality of lenses 31 to 36 constituting the lens group L, the diaphragm members 40 and 41, and the spacer 44 are held and fixed in the optical axis direction in the lens barrel 21 by the inner flange 26 and the inclined surface 23d of the pressing portion 23c.

In addition, a filter 99 such as an infrared cut filter is provided on a lower surface of the inner flange 26.

Further, in the present embodiment, a ring-shaped lens holder 50 that holds the first lens 31 is provided.

The lens holder 50 is manufactured by forming a metal such as SUS into a thin ring shape by turning processing.

The lens holder 50 includes, on an inner peripheral side, a cylindrical inner peripheral surface 50a and an annular surface 50b orthogonal to the inner peripheral surface 50a, and the inner peripheral surface 50a and the annular surface 50b are formed in an L-shaped cross section. The inner peripheral surface 50a is disposed coaxially with the optical axis O, and the annular surface 50b is disposed orthogonal to the optical axis O.

In addition, the lens holder 50 has an inner peripheral surface 50c that is orthogonal to the annular surface 50b and is disposed coaxially with the optical axis O, and the inner peripheral surface 50c is disposed closer to the image side (lower side in FIG. 1) than the inner peripheral surface 50a, and has an inner diameter dimension smaller than that of the inner peripheral surface 50a.

Further, the inner diameter dimension of the inner peripheral surface 50c of the ring-shaped lens holder 50 is larger than an outer diameter dimension of the lens barrel main body 22, whereby the upper end of the lens barrel main body 22 is disposed inside the inner peripheral surface 50c of the lens holder 50.

In addition, the lens holder 50 is joined to the housing 23. That is, an outer peripheral surface 50d and an upper surface 50e of the lens holder 50 abut on an inner periphery of the pressing portion 23c of the housing 23 with substantially no gap, whereby the lens holder 50 is fitted to the top plate 23b of the housing 23. In this manner, the lens holder 50 is joined to the housing 23 having the top plate 23b.

The axis of the lens holder 50 joined to the housing 23 coincides with the optical axis O, and the lens holder 50 is positioned in the optical axis direction.

Further, the lens holder 50 holds the first lens 31. That is, the inner peripheral surface 50a of the lens holder 50 abuts on an outer peripheral surface of the first lens 31 without a gap, whereby the first lens 31 is positioned in the radial direction and disposed coaxially with the optical axis O. Further, the annular surface 50b of the lens holder 50 abuts on a flat bottom surface 31e facing the image side of the first lens 31 without any gap, whereby the first lens 31 is positioned in the optical axis direction.

In addition, since the lenses 32 to 36 arranged closer to the image side than the first lens 31 are held by the lens barrel main body 22 so that the optical axes coincide with each other, and the lens barrel main body 22 is provided coaxially with the support 24 and coinciding with the optical axis O, the first lens 31 and the lenses 32 to 36 arranged closer to the image side than the first lens 31 are arranged coaxially or with a predetermined eccentricity amount or less.

Further, in the present embodiment, a vibration mechanism 60 that vibrates the first lens 31 is included.

The vibration mechanism 60 includes a vibrator 61 that performs ultrasonic vibration, and a vibrating body 62 that transmits the ultrasonic vibration of the vibrator 61 to the first lens 31. Such a vibration mechanism 60 is disposed radially inside the housing 23 and radially outside the lens barrel main body 22.

The vibrator 61 is formed in an annular plate shape and is provided inside the housing main body 23a of the housing 23. The vibrator 61 is formed of, for example, a piezoelectric device.

The vibrating body 62 includes a donut-shaped attachment portion 62a, a main body 62b that extends from the attachment portion 62a toward the object side (upper side in FIG. 1) and has an S-shaped cross-section and a substantially cylindrical shape with a bulge and a constriction due to continuous change in dimensions of an outer diameter and an inner diameter in the axial direction (optical axis direction), and a ring-shaped joint 62c formed at an upper end of the main body 62b. The vibrator 61 is attached and fixed to a lower surface of the attachment portion 62a, and an upper surface of the joint 62c is joined to a lower surface (surface facing the image side) 50f of the lens holder 50 with an adhesive.

In such a vibration mechanism 60, when the vibrator 61 ultrasonically vibrates, the vibrating body 62 ultrasonically vibrates. When the vibrating body 62 vibrates, since the vibrating body 62 is joined to the lens holder 50, the first lens 31 ultrasonically vibrates via the lens holder 50, and this vibration removes foreign matter such as water droplets, muddy water, ice and snow, and frost attached to a lens surface 31a of the first lens 31.

Although the lens holder 50 is fitted to the top plate 23b of the housing 23, since the thickness of the top plate 23b is thinner than the thickness of the housing main body 23a and the top plate 23b functions as a damper, the vibration of the lens holder 50 is less likely to be transmitted to the housing main body 23a. Thus, the vibration is less likely to be transmitted to the support 24 fitted to the housing main body 23a, and as a result, the vibration is less likely to be transmitted to the lens barrel main body 22 fitted to the support 24, and the vibration is less likely to be transmitted to the lenses 32 to 36, so that it is possible to suppress deterioration in optical performance due to positional displacement of the lenses 32 to 36 due to the vibration.

As described above, according to the present embodiment, the ring-shaped lens holder 50 holding the first lens 31 holds the first lens 31 by the inner peripheral surface 50a of the lens holder 50 abutting on the outer peripheral surface of the first lens 31, and is joined to the joint 62c at an end of the vibrating body 62 on the object side.

As described above, since the ring-shaped lens holder 50 is provided separately from the vibrating body 62, the lens holder 50 can secure sufficient processing dimensional accuracy while suppressing variation even in turning processing. Since the first lens 31 held by the lens holder 50 and the lenses 32 to 36 arranged closer to the image side than the first lens 31 are arranged with a predetermined eccentricity amount or less, the first lens 31 can be positioned at a predetermined position without variation, and deterioration of optical performance can be suppressed.

Further, since the lens holder 50 can be made of a material and by a manufacturing method different from those of the vibrating body 62, it is possible to suppress deterioration of optical performance by ensuring dimensional accuracy and securing a predetermined first lens position.

Further, since the lens holder 50 is joined to the housing 23, the lens holder 50 can be reliably attached to a predetermined position. In addition, since the vibration mechanism 60 is disposed radially inside the housing 23 and radially outside the lens barrel main body 22, the vibration mechanism 60 can be protected by the housing 23, and the lenses 32 to 36 arranged closer to the image side than the first lens 31 are held by the lens barrel main body 22, so that the vibration mechanism 60 does not interfere with the lenses 32 to 36.

Furthermore, since the inner peripheral surface 50a of the lens holder 50 abuts on the outer peripheral surface of the first lens 31, and the annular surface 50b of the lens holder 50 abuts on the bottom surface 31e facing the image side of the first lens 31, the first lens 31 can be easily and accurately positioned in the radial direction and the axial direction (optical axis direction).

Note that, in the present embodiment, although the inner peripheral surface 50a and the annular surface 50b of the lens holder 50 are configured to abut on the outer peripheral surface and the bottom surface 31e of the first lens 31, in a case where the first lens 31 particularly varies in position in the radial direction and optical performance deteriorates, at least the inner peripheral surface 50a of the lens holder 50 may abut on the outer peripheral surface of the first lens 31 to hold the first lens 31.

### Second Embodiment

FIG. 3 illustrates a second embodiment, and is a schematic cross-sectional view of a main part of the lens unit 20.

The present embodiment is different from the first embodiment in a joint structure between a lens holder 50 and a vibrating body 62, and other configurations are similar to those of the first embodiment. Therefore, differences will be described below, and the same configurations as those of the first embodiment will be omitted from illustration and description. Note that, in FIG. 3, the same components as those illustrated in FIG. 1 are denoted by the same reference numerals.

In the present embodiment, a fitting portion 50k is formed in the lower surface 50f of the lens holder 50. That is, the lower surface 50f is formed in an annular surface shape orthogonal to the optical axis O, and the fitting portion 50k is formed on the lower surface. The fitting portion 50k is formed by cutting an inner peripheral side of a lower surface 50f at a predetermined depth in the optical axis direction, and includes a cylindrical inner peripheral surface 50h and an annular surface 50j orthogonal to the inner peripheral surface 50h.

The inner peripheral surface 50h and the annular surface 50j are formed in an L-shaped cross section, the inner peripheral surface 50h is disposed coaxially with the optical axis O, and the annular surface 50j is disposed orthogonal to the optical axis O.

A ring-shaped joint 62c formed on the upper portion of the vibrating body 62 is fitted to such a fitting portion 50k and fixed by an adhesive. In this state, an outer peripheral surface of the joint 62c abuts on the inner peripheral surface 50h of the lens holder 50 without a gap, and an upper end surface of the joint 62c abuts on the annular surface 50j without a gap. Thus, the joint 62c of the vibrating body 62 is positioned in the radial direction and the optical axis direction.

According to the present embodiment, in addition to effects similar to those of the first embodiment, since the joint 62c of the vibrating body 62 is fitted to the fitting portion 50k of the lens holder 50, positioning of the vibrating body 62 in the radial direction and the optical axis direction is facilitated, and interference of the vibrating body 62 with the lens barrel main body 22 can be suppressed.

### Third Embodiment

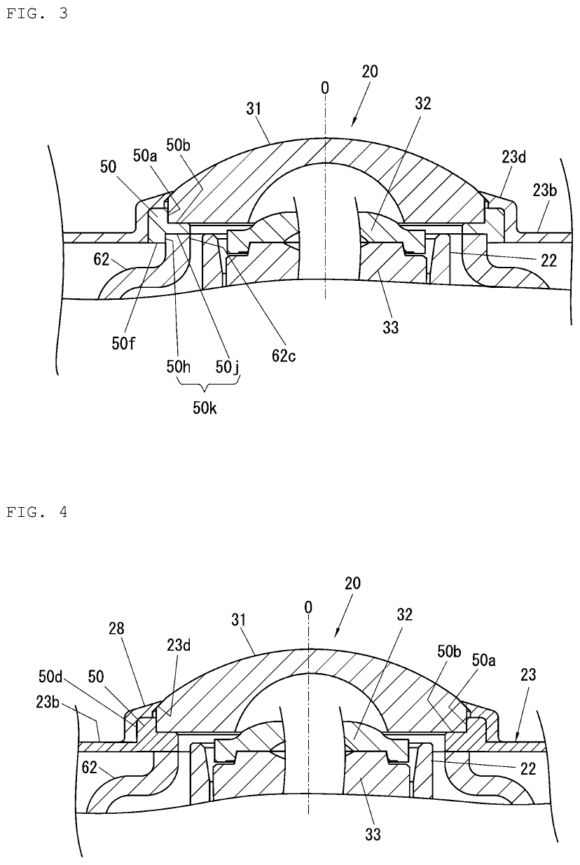

FIG. 4 illustrates a third embodiment, and is a schematic cross-sectional view of a main part of the lens unit 20.

The present embodiment is different from the first embodiment in that the lens holder 50 is formed in the housing 23, and other configurations are similar to those of the first embodiment. Therefore, differences will be described below, and the same configurations as those of the first embodiment will be omitted from illustration and description. Note that, in FIG. 4, the same components as those illustrated in FIG. 1 are denoted by the same reference numerals.

In the present embodiment, the lens holder 50 is formed integrally with the top plate 23b on an inner peripheral edge of the top plate 23b of the housing 23. The lens holder 50 is formed in the same shape as the lens holder 50 of the first embodiment, and the first lens 31 is held by the lens holder 50 similarly to that in the first embodiment.

Further, in the first embodiment, as illustrated in FIG. 1, the pressing portion 23c is integrally formed with the top plate 23b on the inner peripheral edge of the top plate 23b, but in the present embodiment, the lens holder 50 is integrally formed with the top plate 23b on the inner peripheral edge of the top plate 23b, and thus the pressing portion 23c cannot be formed on the top plate 23b. Therefore, in the present embodiment, a lens cap 28 is provided instead of the pressing portion 23c.

The lens cap 28 is formed in a substantially cylindrical shape, and has the same cross-sectional shape as the pressing portion 23c of the first embodiment. Therefore, an inclined surface 23d having the same shape as that of the first embodiment is formed at a distal end of the lens cap 28, and an outer peripheral edge of the first lens 31 is pressed by the inclined surface 23d.

The lens cap 28 may be fitted to the outer peripheral surface 50d of the lens holder 50 or may be screwed to the outer peripheral surface 50d. By attaching the lens cap 28 to the lens holder 50 in this manner, the first lens 31 can be pressed by the inclined surface 23d of the lens cap 28.

According to the present embodiment, effects similar to those of the first embodiment can be obtained, and since the lens holder 50 is integrally formed with the top plate 23b of the housing 23, positioning of the lens holder 50 in the optical axis direction can be more accurately performed, and as a result, positioning of the first lens 31 can be accurately performed without variation in the optical axis direction.

Therefore, variation in the inter-surface distance between the first lens 31 and the second lens 32 can be suppressed, and the variation in optical performance can be further reduced.

Further, since it is not necessary to form the lens holder 50 separately, it is possible to reduce the number of components, improve assembly accuracy, further decrease optical performance variation, and further reduce costs by reducing the number of components.

In addition, since the lens cap 28 is provided, it is possible to prevent the first lens 31 from deviating from the housing 23.

### Fourth Embodiment

FIG. 5 illustrates a fourth embodiment, and is a schematic cross-sectional view of a main part of the lens unit 20.

The present embodiment is different from the first embodiment in that the lens holder 50 is formed in the housing 23, and other configurations are similar to those of the first embodiment. Therefore, differences will be described below, and the same configurations as those of the first embodiment will be omitted from illustration and description. Note that, in FIG. 5, the same components as those illustrated in FIG. 1 are denoted by the same reference numerals.

Further, the present embodiment is similar to the third embodiment in that the lens holder 50 is formed in the top plate 23b of the housing 23, but in the present embodiment, unlike the third embodiment, the lens cap 28 is not provided, and the configuration of the lens holder 50 is changed instead. Therefore, this change will be described below.

In the present embodiment, the lens holder 50 has an L-shaped cross section, and the lens holder 50 has a protrusion length s from the top plate 23b toward the object side (upper side in FIG. 5) longer than that in the third embodiment, and has a radial thickness t thicker than that in the third embodiment.

That is, a cylindrical surface (outer peripheral surface) 31d having a length u in the optical axis direction is formed on an outer peripheral portion of the first lens 31, and a lens surface 31a is formed continuously with the cylindrical surface 31d on the object side from the cylindrical surface 31d. Then, the lens holder 50 has an inner peripheral surface 50a that abuts on the entire surface of the cylindrical surface 31d.

The cylindrical surface (outer peripheral surface) 31d of the first lens 31 is bonded and fixed to the inner peripheral surface 50a with an adhesive.

According to the present embodiment, it is possible to obtain effects similar to those of the first embodiment, and similarly to the third embodiment, since the lens holder 50 is integrally formed on the top plate 23b of the housing 23, positioning of the lens holder 50 in the optical axis direction can be performed more accurately, and as a result, positioning of the first lens 31 in the optical axis direction can be accurately performed without variation.

Further, since the contact surface between the outer peripheral surface 31d of the first lens 31 and the inner peripheral surface 50a of the lens holder 50 is increased as compared with that of the third embodiment, sufficient adhesive strength for preventing the first lens 31 from coming off can be secured. Therefore, since the lens cap 28 required in the third embodiment is unnecessary, the cost can be reduced by reducing the number of parts.

Furthermore, since the thickness t of the lens holder 50 in the radial direction is thicker than that in the case of the third embodiment, the first lens 31 can be held more reliably in the radial direction.

### Fifth Embodiment

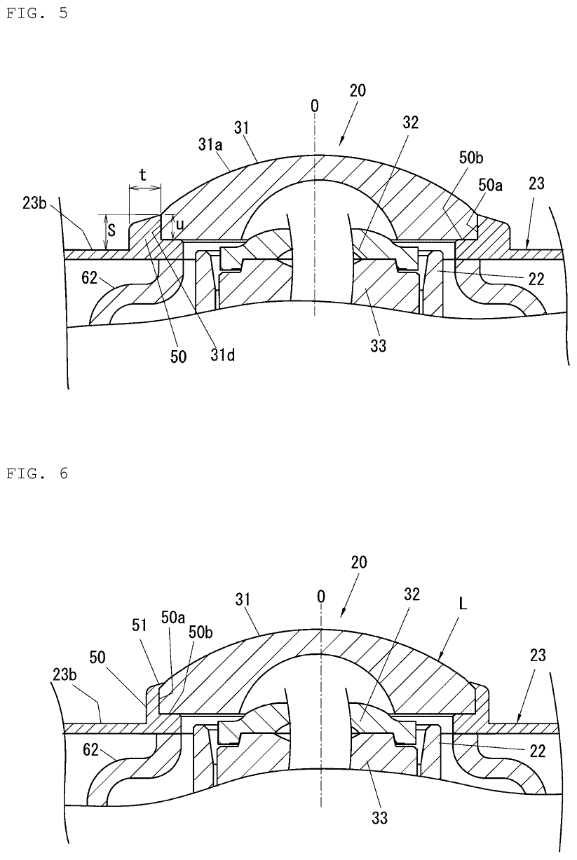

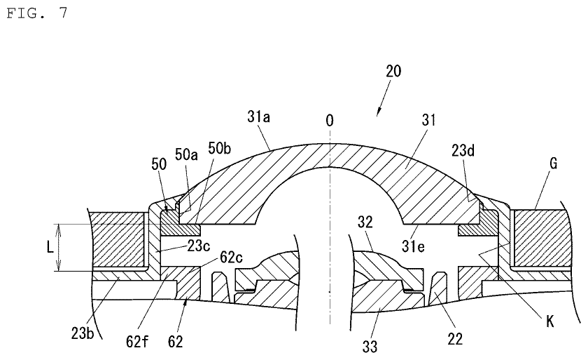

FIG. 6 illustrates a fifth embodiment, and is a schematic cross-sectional view of a main part of the lens unit 20.

The present embodiment is different from the first embodiment in that the lens holder 50 is formed in the housing 23, and other configurations are similar to those of the first embodiment. Therefore, differences will be described below, and the same configurations as those of the first embodiment will be omitted from illustration and description. Note that, in FIG. 6, the same components as those illustrated in FIG. 1 are denoted by the same reference numerals.

Further, the present embodiment is similar to the fourth embodiment in that the lens holder 50 is formed in the top plate 23b of the housing 23, but the present embodiment is different in that the first lens 31 is held by caulking, and this point will be described below.

In the present embodiment, the lens holder 50 is formed to have an L-shaped cross section, and a length of protrusion of the lens holder 50 from the top plate 23b toward the object side (upper side in FIG. 6) is substantially equal to that in the fourth embodiment, but in the present embodiment, a caulking portion 51 is formed at a distal end of the lens holder 50. Further, in the present embodiment, the thickness of the lens holder 50 in the radial direction is thinner than that of the fifth embodiment.

The caulking portion 51 is thermally caulked inward in the radial direction in a state where the lens group L is incorporated and housed and held in the housing 23 and the lens barrel main body 22, whereby the first lens 31 located closest to the object side of the lens group L is fixed in the optical axis direction to the object side end of the lens barrel 21 (the object side end of the housing 23) by the caulking portion 51.

According to the present embodiment, it is possible to obtain effects similar to those of the first embodiment, and similarly to the third and fourth embodiments, since the lens holder 50 is integrally formed on the top plate 23b of the housing 23, positioning of the lens holder 50 in the optical axis direction can be performed more accurately, and as a result, positioning of the first lens 31 in the optical axis direction can be accurately performed without variation.

Further, since the lens cap 28 required in the third embodiment is unnecessary, the cost can be reduced by reducing the number of parts.

### Sixth Embodiment

FIG. 7 illustrates a sixth embodiment, and is a schematic cross-sectional view of a main part of the lens unit 20.

The present embodiment is different from the first embodiment in that the first lens 31 is disposed on an object side (upper side in FIG. 7) in the optical axis direction as compared with the first embodiment, and other configurations are similar to those of the first embodiment. Therefore, differences will be described below, and the same configurations as those of the first embodiment will be omitted from illustration and description. Note that, in FIG. 7, the same components as those illustrated in FIG. 1 are denoted by the same reference numerals.

In the present embodiment, the thin ring-shaped lens holder 50 is disposed on the object side in the optical axis direction as compared with the first embodiment, and the first lens 31 is held by the lens holder 50 similarly to that in the first embodiment.

In order to arrange the lens holder 50 in this manner, a length in the optical axis direction of the pressing portion 23c formed in the top plate 23b of the housing 23 is set to be longer than that in the first embodiment. For example, the length of the pressing portion 23c is set so that the distance L between the bottom surface 31e of the first lens 31 and the top plate 23b is approximately 5 mm. In addition, the lens holder 50 is joined to the pressing portion 23c with an adhesive or the like.

Further, a flange 62f protruding radially outward is formed at the joint 62c at an upper end of the vibrating body 62, and an outer peripheral surface of the flange 62f is joined to an inner peripheral surface of the top plate 23b with an adhesive or the like. Therefore, in the present embodiment, unlike the first embodiment, the lens holder 50 is not directly joined to the upper end of the vibrating body 62, but the lens holder 50 is indirectly joined to the upper end of the vibrating body 62 via another member (the pressing portion 23c formed on the top plate 23b).

Therefore, when the vibrating body 62 is vibrated (ultrasonic vibration) by the piezoelectric device 61, the pressing portion 23c vibrates (ultrasonic vibration) in the optical axis direction, and the first lens 31 vibrates (ultrasonic vibration) via the lens holder 50. Thus, foreign matter such as water droplets, muddy water, ice and snow, and frost attached to the lens surface 31a of the first lens 31 is removed.

According to the present embodiment, effects similar to those of the first embodiment can be obtained, and the first lens 31 can largely protrude from the top plate 23b of the housing 23 toward the object side in the optical axis direction, so that an aperture on a vehicle side when attached to the vehicle can be set to be substantially the lens (first lens 31) size (minimum necessary) or slightly larger than the lens size.

That is, in the first embodiment, in order to cause the first lens 31 to protrude forward from a front surface of an attachment portion G such as a grille on a front surface of the vehicle, for example, it is necessary to provide a relatively large aperture into which the top plate 23b of the housing 23 can be fitted in the attachment portion G, whereas in the present embodiment, since the first lens 31 protrudes larger than the top plate 23b, it is sufficient to provide a small aperture K into which the first lens 31 can be fitted in the attachment portion G, and the size of the aperture K can be minimized.

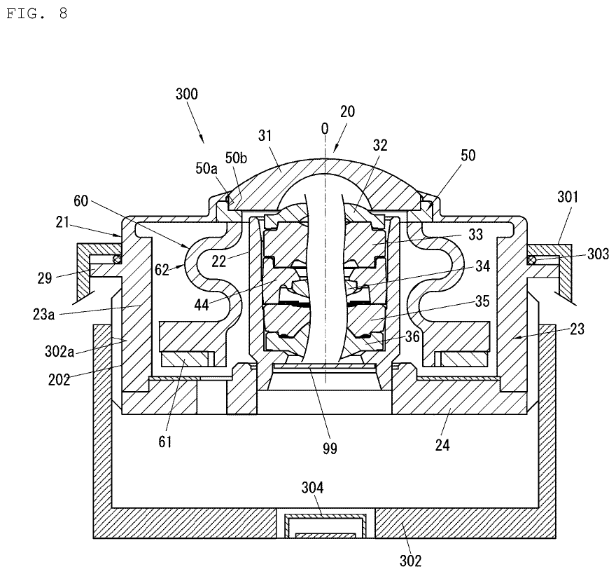

FIG. 8 is a schematic cross-sectional view of a camera module 300 of the present embodiment having the lens unit 20 illustrated in FIG. 1. As illustrated in the drawing, the camera module 300 includes a lens unit 20 to which a filter 99 is attached. Further, the lens unit 20 is formed so that a length of the support 24 in the optical axis direction is shorter than that of the lens unit 20 illustrated in FIG. 1, and an outer diameter of the support 24 is reduced to be equal to an outer diameter of the housing main body 23a.

Note that the lens unit 20 may be the lens unit 20 described in any one of the second to sixth embodiments.

The camera module 300 includes an upper case (camera case) 301 that is an exterior component, and a mount (base) 302 that holds the lens unit 20. Further, the camera module 300 includes a sealing material 303 and a package sensor (image sensor) 304.

The upper case 301 is a member that is engaged with an outer flange 29 provided in a flange shape on an outer peripheral surface of the lens barrel 21 and exposes an end of the lens unit 20 on the object side to cover the other portion. The mount 302 is disposed inside the upper case 301 and has a female screw 302a screwed with a male screw 202 of the lens unit 20. The sealing material 303 is a member interposed between an inner surface of the upper case 301 and the outer peripheral surface of the lens barrel 21 of the lens unit 20, and is a member for maintaining airtightness inside the upper case 301.

The package sensor 304 is disposed inside the mount 302 so as to face the filter 99, and is disposed at a position where an image of an object formed by the lens unit 20 is received. Further, the package sensor 304 includes a CCD, a CMOS, or the like, and converts light condensed and arriving through the lens unit 20 into an electrical signal. The converted electrical signal is converted into analog data or digital data which is a component of image data captured by the camera.

FIG. 9 schematically illustrates a vehicle 240 as a mobile body on which an in-vehicle system (imaging system) including the imaging apparatus 250 including the camera module 300 illustrated in FIG. 8 is mounted. As illustrated, the imaging apparatus 250 can be mounted on the vehicle 240, and FIG. 9 is an arrangement example illustrating a mounting position of the imaging apparatus 250 in the vehicle 240. The imaging apparatus 250 mounted on the vehicle 240 can also be referred to as an in-vehicle camera, and can be installed at various places of the vehicle 240. For example, a first imaging apparatus 250a may be disposed at or near a front bumper as a camera for monitoring the front when vehicle 240 travels. In addition, a second imaging apparatus 250b that monitors the front may be disposed near an inner rearview mirror in the cabin of vehicle 240. The third imaging apparatus 250c may be disposed on a dashboard, in an instrument panel, or the like as a camera for monitoring the driving situation of the driver. The fourth imaging apparatus 250d may be installed at the rear of the vehicle 240 for rear monitoring of the vehicle 240. The imaging apparatuses 250a and 250b can be referred to as front cameras. The third imaging apparatus 250c can be referred to as an in-camera. The fourth imaging apparatus 250d can be referred to as a rear camera. The imaging apparatus 250 is not limited thereto, and includes imaging apparatuses installed at various positions such as a left side camera that images a left rear side and a right side camera that images a right rear side.

An image signal of an image captured by the imaging apparatus 250 can be output to an information processing apparatus 242 and/or a display apparatus 243 in the vehicle 240. The information processing apparatus 242 and the display apparatus 243 constitute an in-vehicle system together with the imaging apparatus 250. The information processing apparatus 242 in the vehicle 240 includes a apparatus that processes the image signal acquired by the imaging apparatus 250, recognizes the image, and assists the driver in driving. Further, the information processing apparatus 242 includes, for example, a navigation apparatus, a collision damage reduction brake apparatus, an inter-vehicle distance control apparatus, a lane departure warning apparatus, and the like, but is not limited thereto. The display apparatus 243 displays an image processed and output by the information processing apparatus 242, but can also directly receive the image signal from the imaging apparatus 250. In addition, the display apparatus 243 may employ a liquid crystal display (LCD), an organic electro-luminescence (EL) display, and an inorganic EL display, but is not limited thereto. The display apparatus 243 can display, to the driver, the image signal output from the imaging apparatus 250 that captures an image of a position difficult to be visually recognized by the driver, such as the rear camera (can output information for the occupant).

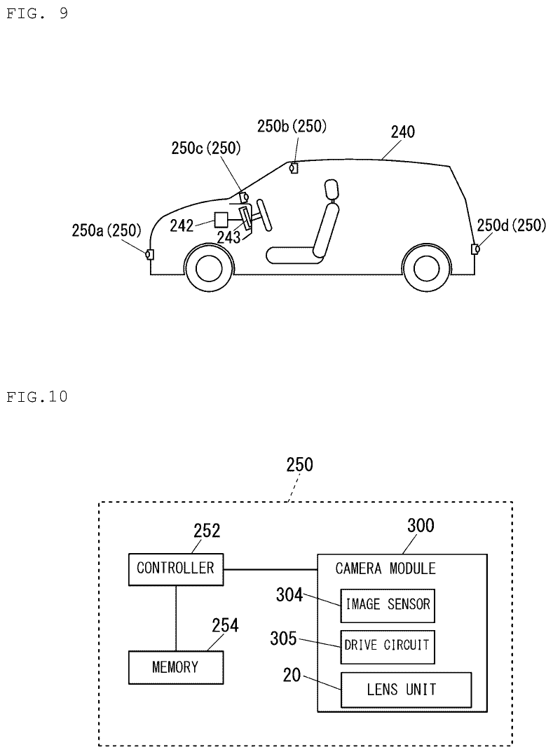

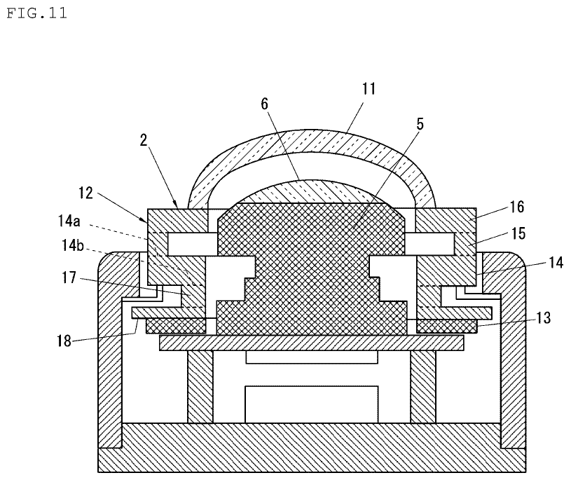

FIG. 10 illustrates a configuration of an imaging apparatus included in the in-vehicle system illustrated in FIG. 9. As illustrated, the imaging apparatus 250 according to the embodiment includes a controller 252, a memory 254, and the camera module 300 illustrated in FIG. 8 described above.

The controller 252 controls the camera module 300 and processes an electrical signal output from the image sensor 304 of the camera module 300. The controller 252 may be configured as, for example, a processor. Further, the controller 252 may include one or more processors. The processor may include a general-purpose processor that loads a specific program and executes a specific function, and a dedicated processor specialized for specific processing. The dedicated processor may include an application-specific integrated circuit (IC). The application-specific IC is also referred to as an application specific integrated circuit (ASIC). The processor may include a programmable logic device. The programmable logic device is also referred to as a programmable logic device (PLD). The PLD may include a field-programmable gate array (FPGA). The controller 252 may be either a system-on-a-chip (SoC) in which one or more processors cooperate or a system in a package (SiP).

The memory 254 stores various types of information or parameters related to the operation of the imaging apparatus 250. The memory 254 may include, for example, a semiconductor memory or the like. The memory 254 may function as a work memory of the controller 252. The memory 254 may store a captured image. The memory 254 may store various parameters and the like for the controller 252 to perform detection processing based on the captured image. The memory 254 may be included in the controller 252.

As described above, the camera module 300 captures a subject image formed via the lens unit 20 by the image sensor 304, and outputs the captured image. The image captured by the camera module 300 is also referred to as a captured image.

The image sensor 304 may be constituted by, for example, a complementary metal oxide semiconductor (CMOS) image sensor, a charge coupled device (CCD), or the like.

The image sensor 304 has an imaging surface on which a plurality of pixels is arranged. Each pixel outputs a signal specified by a current or a voltage according to the amount of incident light. The signal output from each pixel is also referred to as imaging data.

The imaging data may be read out by the camera module 300 for all the pixels and taken into the controller 252 as a captured image. The captured image read for all the pixels is also referred to as a maximum captured image. The imaging data may be read by the camera module 300 for some pixels and captured as a captured image. In other words, the imaging data may be read from pixels in a predetermined capturing range. The imaging data read from the pixels in the predetermined capturing range may be captured as a captured image. The predetermined capturing range may be set by the controller 252. The camera module 300 may acquire a predetermined capturing range from the controller 252. The image sensor 304 may capture an image in a predetermined capturing range of the subject image formed via the lens unit 20.

Further, in the present embodiment, the camera module 300 includes a drive circuit 305. The drive circuit 305 is a circuit that applies a voltage of a predetermined frequency to the piezoelectric device 61 of the vibration mechanism 60 to drive the piezoelectric device.

Note that the present invention is not limited to the embodiments described above, and various modifications can be made without departing from the gist thereof. For example, in the present invention, the shape and the like of the lens, the lens barrel, and the like are not limited to the embodiments described above. In addition, a part or all of the embodiments described above may be combined, or a part of the configuration may be omitted from one of the above-described embodiments without departing from the gist of the present invention.

### REFERENCE SIGNS LIST

20 Lens unit
21 Lens barrel
22 Lens barrel main body
23 Housing
24 Support
31 First lens
31d Outer peripheral surface
31e Bottom surface
32 to 36 Lens
50 Lens holder
50a Inner peripheral surface
50b Annular surface
60 Vibration mechanism
61 Piezoelectric device (vibrator)
62 Vibrating body
240 Vehicle (mobile body)
242 Information processing apparatus (processing apparatus)
243 Display apparatus
250 Imaging apparatus
252 Controller
300 Camera module
304 Image sensor

1. A lens unit comprising a lens group in which a plurality of lenses is arranged along an optical axis of the lenses, a lens barrel that houses and holds the lens group, and a vibration mechanism that vibrates a first lens located closest to an object side among the plurality of lenses, wherein
the vibration mechanism includes a vibrator and a cylindrical vibrating body that is fixed to the vibrator and is vibrated by the vibrator,
the lens unit comprises a ring-shaped lens holder that holds the first lens,
the lens holder holds the first lens by at least an inner peripheral surface of the lens holder abutting on an outer peripheral surface of the first lens,
the lens holder is directly or indirectly joined to an end of the vibrating body on the object side, and
the first lens and a lens arranged closer to an image side than the first lens are arranged with a predetermined eccentricity amount or less.

2. The lens unit according to claim 1, wherein the lens barrel includes:
a lens barrel main body that holds a lens disposed closer to the image side than the first lens; and
a housing that is disposed radially outside the lens barrel main body and holds the first lens via the lens holder,
the lens holder is joined to the housing or formed integrally with the housing, and
the vibration mechanism is disposed radially inside the housing and radially outside the lens barrel main body.

3. The lens unit according to claim 1, wherein the lens holder includes a cylindrical inner peripheral surface and an annular surface orthogonal to the inner peripheral surface, and
the inner peripheral surface abuts on an outer peripheral surface of the first lens, and the annular surface abuts on a bottom surface of the first lens facing the image side.

4. A camera module comprising: the lens unit according to claim 1; and an image sensor that converts light condensed through the lens group of the lens unit into an electrical signal.

5. An imaging system comprising:
an imaging apparatus including the camera module according to claim 4 and a controller that controls the camera module and processes an electrical signal output from an image sensor of the camera module;
a processing apparatus that processes an image signal acquired by the imaging apparatus; and
a display apparatus that displays an image processed and output by the processing apparatus.

6. A mobile body comprising the imaging system according to claim 5, wherein the display apparatus outputs information for an occupant.
